(19) United States
(12) Patent Application Publication
(10) Pub. No.: US 2020/0310443 A1
(43) Pub. Date: Oct. 1, 2020

(54) APPARATUS AND METHOD FOR PROVIDING FOUR-DIMENSIONAL EFFECT IN VEHICLE

(71) Applicants: Hyundai Motor Company, Seoul (KR); Kia Motors Corporation, Seoul (KR)

(72) Inventors: Ki Beom Kwon, Hwaseong (KR); Sang Su Kim, Seoul (KR); Jun Kyung Lee, Seoul (KR); Jong Yong Nam, Seongnam (KR)

(21) Appl. No.: 16/588,084

(22) Filed: Sep. 30, 2019

(30) Foreign Application Priority Data
Apr. 1, 2019 (KR) 10-2019-0038014

(51) Int. Cl. G05D 1/02; G05D 1/00; B60Q 9/00; B60W 30/09

(52) U.S. Cl. CPC G05D 1/0214; G05D 1/0044; G05D 1/005; B60Q 9/008; B60W 2540/22; G05D 1/0276; G05D 1/0223; G05D 2201/0213; B60W 30/09

(57) ABSTRACT

An apparatus and a method provide a four-dimensional effect to a driver and/or passengers of a vehicle. The apparatus includes a first vehicle controller that analyzes data of content played in an electronic device, sets four-dimensional effect information and generates vehicle control information for realizing the four-dimensional effect according to the set four-dimensional effect information, and a second vehicle controller that performs vehicle control based on the vehicle control information in consideration of a driving status of a vehicle.

### CROSS-REFERENCE TO RELATED APPLICATION

This application claims under 35 U.S.C. § 119(a) the benefit of Korean Patent Application No. 10-2019-0038014, filed in the Korean Intellectual Property Office on Apr. 1, 2019, the entire contents of which are incorporated herein by reference.

### BACKGROUND

### (a) Technical Field

The present disclosure relates to an apparatus and a method for providing a four-dimensional effect in a vehicle, more particularly, to the apparatus and the method for providing the four-dimensional effect to a driver and/or passenger(s) occupying the vehicle.

### (b) Description of the Related Art

Autonomous driving technology is classified into six levels, i.e., from level 0 to level 5, according to the classification scheme of the Society of Automotive Engineers (SAE). A driving entity of an autonomous driving vehicle of level 3 or higher is considered a system, not a person. Therefore, it will become important for a user to efficiently spend time in the vehicle while performing activities other than driving when the autonomous driving vehicle of level three or higher travels from a departure point to a destination. However, it is necessary to provide a way for the user to comfortably spend time in the vehicle without feeling confined because the interior space of the vehicle is a closed space in which movement is limited.

### SUMMARY

An aspect of the present disclosure provides an apparatus and a method for providing a four-dimensional effect in a vehicle, capable of providing the four-dimensional effect to a driver and/or passenger(s) occupying the vehicle, which is carried out by controlling the vehicle based on data of virtual reality content during driving of the vehicle.

According to an aspect of the present disclosure, an apparatus for providing a four-dimensional effect in a vehicle includes a first vehicle controller that analyzes data of content played in an electronic device, sets four-dimensional effect information and generates vehicle control information for realizing the four-dimensional effect according to the set four-dimensional effect information, and a second vehicle controller that performs vehicle control based on the vehicle control information in consideration of a driving status of a vehicle.

The electronic device may be implemented with any one of a Virtual Reality (VR) device, a head mounted display, a wearable device, a smartphone, an Audio Video Navigation (AVN), and a vehicle display device.

The first vehicle controller may set the four-dimensional effect information based on at least one of the position data, acceleration/deceleration data, temperature data, season data, and weather data included in the content

The second vehicle controller may realize the four-dimensional effect by controlling steering using left and right lanes of a road on which the vehicle is driving when a forward collision warning and a backside collision warning (BCW) are not functional.

The second vehicle controller may realize the four-dimensional effect by controlling steering within a lane on which the vehicle is driving when at least one of a forward collision warning and a backside collision warning (BCW) is functional.

The second vehicle controller may limit speed control and steering control of the vehicle when a driving speed of the vehicle is equal to or less than a predetermined reference speed.

The second vehicle controller may provide the electronic device with notification information notifying limit to the speed control and the steering control of the vehicle.

The second vehicle controller may limit speed control and steering control of the vehicle for realizing the four-dimensional effect when a wiper of the vehicle is in operation.

The second vehicle controller may determine whether a user emergency situation occurs in cooperation with a health care system, and stop content reproduction of the electronic device based on a result of the determination.

The second vehicle controller may allow the vehicle to stop on a shoulder of a mad and perform an emergency rescue request

According to an aspect of the present disclosure, an apparatus for providing a four-dimensional effect in a vehicle includes: a communicator that receives from an electronic device four-dimensional effect information generated by analyzing data of content played in the electronic device, a first vehicle controller including a processor that generates vehicle control information for realizing the four-dimensional effect according to the four-dimensional effect information, and a second vehicle controller that performs vehicle control based on the vehicle control information in consideration of a driving status of a vehicle.

According to an aspect of the present disclosure, a method for providing a four-dimensional effect in a vehicle includes analyzing data of content played in an electronic device and setting four-dimensional effect information, generating vehicle control information for realizing the four-dimensional effect according to the four-dimensional effect information, and performing vehicle control based on the vehicle control information in consideration of a driving status of a vehicle.

The electronic device is implemented with any one of a Virtual Reality (VR) device, a head mounted display, a wearable device, a smartphone, an Audio Video Navigation (AVN), and a vehicle display device.

The setting of the four-dimensional effect information may include setting the four-dimensional effect information based on at least one of the position data, acceleration/deceleration data, temperature data, season data, and weather data included in the content

The performing of the vehicle control may include realizing the four-dimensional effect by controlling steering using left and right lanes of a road on which the vehicle is driving when a forward collision warning and a backside collision warning (BCW) are not functional.

The performing of the vehicle control may include realizing the four-dimensional effect by controlling steering within a lane on which the vehicle is driving when at least one of a forward collision warning and a backside collision warning (BCW) is functional.

The performing of the vehicle control may include limiting speed control and steering control of the vehicle when a driving speed of the vehicle is equal to or less than a predetermined reference speed.

The performing of the vehicle control may include providing the electronic device with notification information notifying limit to the speed control and the steering control of the vehicle.

The performing of the vehicle control may include limiting speed control and steering control of the vehicle for realizing the four-dimensional effect when a wiper of the vehicle is in operation.

The performing of the vehicle control may include determining whether a user emergency situation occurs in cooperation with a health care system, and stopping content reproduction of the electronic device based on a result of the determination.

The performing of the vehicle control may include allowing the vehicle to stop on a shoulder of a road and performing an emergency rescue request

### BRIEF DESCRIPTION OF THE DRAWINGS

The above and other objects, features and advantages of the present disclosure will be more apparent from the following detailed description taken in conjunction with the accompanying drawings:

FIG. 1 is a configuration diagram illustrating an apparatus for providing a four-dimensional effect in a vehicle according to an embodiment of the present disclosure;

FIG. 2 is a configuration diagram of an electronic device illustrated in FIG. 1;

FIG. 3 is a configuration diagram of a first vehicle controller illustrated in FIG. 1;

FIG. 4 is a block diagram illustrating a second vehicle controller illustrated in FIG. 1;

FIG. 5 is a flowchart illustrating a method for providing a four-dimensional effect in a vehicle according to an embodiment of the present disclosure;

FIG. 6 is an exemplary diagram illustrating an example for providing a four-dimensional effect in a vehicle according to the present disclosure;

FIG. 7 is an exemplary diagram illustrating another example for providing a four-dimensional effect according to the present disclosure; and

FIG. 8 is a block diagram of a computing system for executing a method for providing a four-dimensional effect in a vehicle according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

The present disclosure may perform vehicle control based on data of content played in an electronic device in consideration of a driving status of a vehicle to realize four-dimensional effect when a user is enjoying content played in a virtual reality (VR) device in the vehicle during driving of an autonomous driving vehicle of a three or higher level, thereby providing the user with fun entertainment elements which the user is able to feel with the user's body in addition to visual entertainment elements.

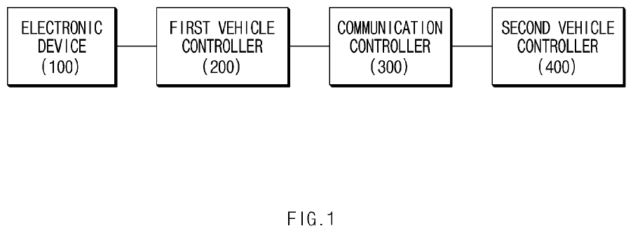

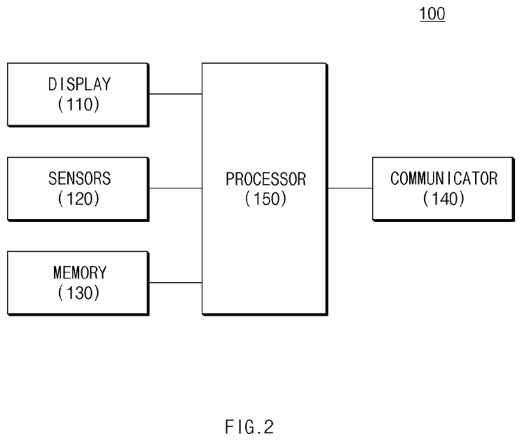

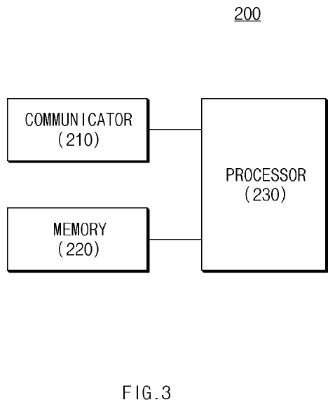

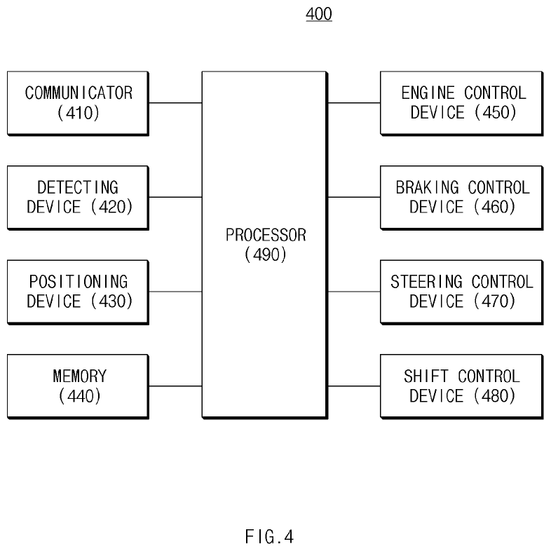

FIG. 1 is a configuration diagram illustrating an apparatus for providing a four-dimensional effect according to an embodiment of the present disclosure, FIG. 2 is a configuration diagram of an electronic device illustrated in FIG. 1, FIG. 3 is a configuration diagram of a first vehicle controller illustrated in FIG. 1, and FIG. 4 is a block diagram illustrating a second vehicle controller illustrated in FIG. 1.

Referring to FIG. 1, an apparatus for providing a four-dimensional effect in a vehicle may include an electronic device 100, a first vehicle controller 200, a communication controller 300, and a second vehicle controller 400.

The electronic device 100 may be an image display device for outputting VR content (e.g., games and movies), and implemented with any one of a VR device, a head mounted display (HMD), a wearable device, a smartphone, an Audio Video Navigation (AVN) and a vehicle display device. The electronic device 100 may include a display 110, sensors 120, a memory 130, a communicator 140, and a processor 150.

The display 110 may be disposed in front of both of a user's eyes when the electronic device 100 is worn on the user's head. A three-dimensional (3D) image using sight difference is projected onto the display 110. The display 110 may be implemented with at least one of a display such as a liquid crystal display (LCD), a thin film transistor liquid crystal display (TFT LCD), an organic light-emitting diode (OLED) display, a flexible display, and a transparent display.

The sensors 120 may track movement of the user's head and/or gaze, or the like. The sensors 120 may include an acceleration sensor, a gyro sensor, a magnetic field sensor, a visual sensor or the like. The sensors 120 may further include an infrared sensor mounted on a front surface portion of the electronic device 100 to scan an indoor space of the vehicle which a user is boarding. Also, the sensors 120 may further include a camera, that is, an image sensor to enable realization of augmented reality.

The memory 130 may store software programmed to cause the processor 150 to execute predetermined operation(s). The memory 130 may store content, settings information or the like. The memory 130 may be implemented with at least one storage medium (recording medium) of storage media such as a flash memory, a hard disk, an SD card (Secure Digital Card), a random access memory (RAM), a static random access memory (SRAM), a Read Only Memory (ROM), a Programmable Read Only Memory (PROM), an Electrically Erasable and Programmable ROM (EEPROM), an Erasable and Programmable ROM (EPROM), a register, a removable disk and a web storage.

The communicator 140 may perform wired and/or wireless communication. The communicator 140 may receive content from an external device (e.g., a content providing server, a smartphone, a computer and/or a notebook computer). Further, the communicator 140 may receive content transmitted from the first vehicle controller 200. As wireless communication technology, there may be used wireless Internet technology such as Wireless LAN (Wi-Fi), Wibro (Wireless broadband) and Wimax (World Interoperability for Microwave Access), short range communication technology such as Bluetooth, Near Field Communication (NFC), Radio Frequency identification (RFID), infrared data association (IrDA), and ZigBee, and/or mobile communication technology such as CDMA (Code Division Multiple Access), GSM (Global System for Mobile communication), LTE (Long Term Evolution) and LTE-Advanced. Serial communication technology, such as a Universal Serial Bus (USB) may be used as the wired communication technology.

The processor 150 may control overall operation of the electronic device 100. The processor 150 may allow the display 110 to play content and display the played content as a stereoscopic image. In this case, the processor 150 may play content stored in the memory 130 or play content received through the communicator 140. The processor 150 may be implemented with at least one of an application specific integrated circuit (ASIC), a digital signal processor (DSP), a programmable logic device (PLD), field programmable gate array (FPGAs), a central processing unit (CPU), microcontrollers, and microprocessors.

The processor 150 may analyze data of the content while reproducing content to set four-dimensional effect information. The four-dimensional effect information may include an effect type (e.g., wind, vibration, temperature, light, speed, and/or movement), an effect strength, an effect duration time, and the like. The processor 150 may transmit the set four-dimensional effect information to the first vehicle controller 200 through the communicator 140.

In addition, the processor 150 may generate vehicle control information for realizing a four-dimensional effect according to the set four-dimensional effect information. In this case, the processor 150 may generate the vehicle control information by referring to a lookup table stored in the memory 130 in advance.

The electronic device 100 may further include a microphone for receiving speech of the user, a sound output device for outputting audible information, a hand position tracker for tracking a position of a user's hand, and a tactile generator for outputting a tactile signal, and the like.

The first vehicle controller 200 may analyze data of content played in the electronic device 100, set four-dimensional effect and generate vehicle control information for realizing the set four-dimensional effect. The first vehicle controller 200 may be implemented with a vehicle head unit or a computing device mounted on the vehicle. The first vehicle controller 200 may include a communicator 210, a memory 220 and a processor 230.

The communicator 210 may perform wired and/or wireless communication. The communicator 210 may perform data communication with the communicator 140 of the electronic device 100. The communicator 210 may transmit content to the electronic device 100 according to an instruction from the processor 230.

The communicator 210 may use wireless communication technology, such as Wireless LAN (Wi-Fi), Wireless broadband (Wibro) and World Interoperability for Microwave Access (Wimax), short range communication technology such as Bluetooth, Near Field Communication (NFC), Radio Frequency identification (RFID), infrared data association (IrDA), and ZigBee, and/or mobile communication technology such as Code Division Multiple Access (CDMA), Global System for Mobile communication (GAM), Long Term Evolution (LTE) and LTE-Advanced. The communicator 210 may also use serial communication technology, such as a Universal Serial Bus (USB).

The memory 220 may store a program for operation of the processor 230, and temporarily store input and/or output data. The memory 220 may be implemented with at least one storage medium (recording medium) of storage media such as a flash memory, a hard disk, an Secure Digital card (SD Card), a random access memory (RAM), a static random access memory (SRAM), a Read Only Memory (ROM), a Programmable Read Only Memory (PROM), an Electrically Erasable and Programmable ROM (EEPROM), an Erasable and Programmable ROM (EPROM), a register, a removable disk and/or a web storage.

The memory 220 may store a lookup table in which vehicle function-controls (e.g., air conditioning control, multimedia control, seat control, acceleration/deceleration control or the like) mapped to four-dimensional effect information are defined.

The processor 230 may analyze the data (e.g., position data, acceleration/deceleration data, temperature data, season data, weather data, and the like) of content played in the electronic device 100 and set (determine) four-dimensional effect (event) information to be provided to the user. The processor 230 may set the four-dimensional effect information based on at least one of the position data, acceleration/deceleration data, temperature data, season data, and weather data included in the content. For example, the processor 230 may determine (select) a type of the four-dimensional effect corresponding to the data of the content played in the electronic device 100.

In addition, the processor 230 may generate vehicle control information for realizing four-dimensional effect according to the set four-dimensional effect information. For example, the processor 230 may extract the position and orientation information of the user from the data of the content when the type of the set four-dimensional effect is a left-to-right motion, and generate steering control information of the vehicle based on the extracted position and orientation information of the user.

On the other hand, the processor 230 may receive and process the four-dimensional effect information or the vehicle control information transmitted from the electronic device 100 through the communicator 210. For example, when receiving the four-dimensional effect information, the processor 230 may generate vehicle control information for realizing the four-dimensional effect according to the four-dimensional effect information to control a behavior of the vehicle. When receiving the vehicle control information, the processor 230 may control the behavior of the vehicle based on the vehicle control information.

The communication controller (Central Gateway, CGW) 300 may be mounted on the vehicle and may be connected to the first vehicle controller 200 through a first communication network and is connected to the second vehicle controller 400 through a second communication network different from the first communication network. As provided herein, the first communication network and the second communication network may be implemented with an In-Vehicle Networking (IVN) such as a Controller Area Network (CAN), a Media Oriented Systems Transport (MOST) network, a Local Interconnect Network (LIN) and/or Flexray, a wired Internet network such as Ethernet, and/or a local area network such as Bluetooth and NFC (Near Field Communication).

The communication controller 300 may serve to connect the first vehicle controller 200 and the second vehicle controller 400. In other words, the communication controller 300 may transmit vehicle control information output from the first vehicle controller 200 to the second vehicle controller 400, and transmit vehicle control information transmitted from the second vehicle controller 400 to the first vehicle controller 200. The communication controller 300 may include a processor (not shown) and a memory (not shown).

The second vehicle controller 400 is an electronic control unit (ECU) that controls predetermined vehicle functions. Although the single second vehicle controller 400 is illustrated as being connected to the communication controller 300 in FIG. 1, two or more second vehicle controllers 400 may be connected thereto. Accordingly, the communication controller 300 may transmit the information received from the first vehicle controller 200 to any one of the second vehicle controllers 400. The second vehicle controller 400 may include a dual automatic temperature control (DATC) system, an Advanced Driver Assistance System (ADAS), an engine management system (EMS), a body ECU, a powertrain ECU, or an infotainment ECU.

The following description will be given under assumption that the second vehicle controller 400 is an advanced driver assistance system (ADAS). Referring to FIG. 4, the second vehicle controller 400 may include a communicator 410, a detecting device 420, a positioning device 430, a memory 440, an engine control device 450, a braking control device 460, a steering control device 470, a shift control device 480, and a processor 490.

The communicator 410 may allow the second vehicle controller 400 to transmit and receive information (data) to and from another electronic control device mounted on the vehicle through the communication controller 300. In other words, the communicator 410 may allow the second vehicle controller 400 to access an in-vehicle network (IVN) such as CAN, LIN, Flexray, or MOST and/or a wired Internet network such as Ethernet. The communicator 410 may support International Mobile Telecommunication (IMT)-2020, that is, fifth generation mobile communication.

The detecting device 420 may obtain (detect) surroundings information of the vehicle through a Radio Detecting And Ranging (RADAR), a Light Detection And Ranging (LIDAR), an ultrasonic sensor and/or an image sensor.

The positioning device 430 may measure a current position of the vehicle. The positioning device 430 may measure a position of the vehicle using at least one of positioning techniques such as Global Positioning System (GPS), Dead Reckoning (DR), Differential GPS (DGPS), and Carrier Phase Differential GPS (CDGPS).

The memory 440 may store software programmed to cause the processor 490 to execute predetermined operation. The memory 440 may be implemented with at least one of storage media, such as a flash memory, a hard disk, an SD card, a random access memory (RAM), a static random access memory (SRAM), a read only memory (ROM), a Programmable Read Only Memory (PROM), an Electrically Erasable and Programmable ROM (EEPROM), a Erasable and Programmable ROM (EPROM), and a register.

The memory 440 may store map data, sensor data obtained through the detecting device 420, vehicle information provided from other electronic control devices, and the like. The memory 440 may store image processing algorithms, position estimation algorithms, route generation algorithms, autonomous driving algorithms, and the like.

The engine control device 450 may control an engine of the vehicle, and may be implemented with an Engine Management System (EMS) or a motor control unit. The engine control device 450 may control acceleration of the vehicle by controlling the drive torque of the engine according to accelerator pedal position information output from an accelerator pedal position sensor. In addition, the engine control device 450 may control an engine output to follow a driving speed of the vehicle according to an instruction from the processor 490.

The braking control device 460 may control deceleration of the vehicle and may be implemented with an electronic stability control (ESC) system. The braking control device 460 may control a braking pressure according to a position of a brake pedal or control the braking pressure under the control of the processor 490.

The steering control device 470 may control steering of the vehicle and may be implemented with a Motor Drive Power Steering (MDPS) system. The steering control device 470 may control a steering angle of the vehicle according to an instruction from the processor 490.

The shift control device 480 is for controlling a transmission (shift) of the vehicle, and may be implemented with an electric shifter (Shift By Wire, SBW). The shift control device 480 may control shift of the vehicle according to a gear position and a range of a gear state.

The processor 490 may control at least one of the engine control device 450, the braking control device 460, the steering control device 470, and the shift control device 480 to control the behavior of the vehicle. Although the processor 490 is illustrated as being directly connected to the engine control device 450, the braking control device 460, the steering control device 470 and the shift control device 480 in FIG. 4, but may be connected through the communication controller 300.

The processor 490 may collect surroundings information of the vehicle through the detecting device 420 during autonomous driving and determine the driving situation of the vehicle. In addition, the processor 490 may determine the driving status of the vehicle through communication with another ECU mounted on the vehicle. For example, the processor 490 may determine whether there is another vehicle approaching vehicle in the periphery of the vehicle according to whether a function, such as a forward collision warning and/or a backside collision warning (BCW) provided from another ECU is functional.

The processor 490 may control the vehicle based on the driving status of the vehicle and the vehicle control information provided from the first vehicle controller 200. In other words, the processor 490 may control the behavior of the vehicle based on the vehicle control information in consideration of the driving status of the vehicle. The processor 490 may output (realize) the four-dimensional effect corresponding to the driving status of the vehicle and the data of the content played in the electronic device 100 by controlling the behavior of the vehicle.

The processor 490 may determine whether the forward collision warning and the backside collision warning are functional when the four-dimensional effect is a left-right motion. When the forward collision warning and the backside collision warning are not functional, the processor 490 may control the steering by utilizing the left and right lanes of a road on which the vehicle is driving to realize the set four-dimensional effect

On the other hand, the processor 490 may control steering in the driving lane of the vehicle when at least one of the forward collision warning and the backside collision warning is functional to realize the set four-dimensional effect

The processor 490 may obtain a driving speed of the vehicle through a sensor or another ECU. The processor 490 may limit the speed control and the steering control of the vehicle when the driving speed of the vehicle is equal to or less than a predetermined reference speed (e.g., 60 km/h). In other words, the processor 490 may not perform the speed control and the steering control of the vehicle for realizing the four-dimensional effect when the vehicle is driving in a congested section.

In addition, the processor 490 may provide the electronic device 100 with notification information notifying limitation to the speed control and the steering control of the vehicle. The electronic device 100 may output a notification to the display 110.

The processor 490 may limit the speed control and the steering control of the vehicle for realizing the set four-dimensional effect when a wiper of the vehicle is in operation. The processor 490 may determine that the vehicle is driving on a wet or snowy road and may not perform the speed control and the steering control of the vehicle for realizing the four-dimensional effect

The processor 490 may operate in cooperation with a health care system (not shown) to determine a user emergency situation. The processor 490 may stop content reproduction of the electronic device 100. For example, the processor 490 may measure a heart rate of the user through a sensor mounted on a steering wheel, determine that an emergency situation occurs when the measured heart rate of the user is out of a predetermined reference range of heart rates, and instruct the electronic device 100 to stop the content reproduction. The electronic device 100 may receive an instruction transmitted from the processor 490 through the first vehicle controller 200 and stop the content reproduction according to the received instruction.

When it is determined that the user is in an emergency situation, the processor 490 may allow the vehicle to stop on the shoulder of a road, and perform an emergency rescue request

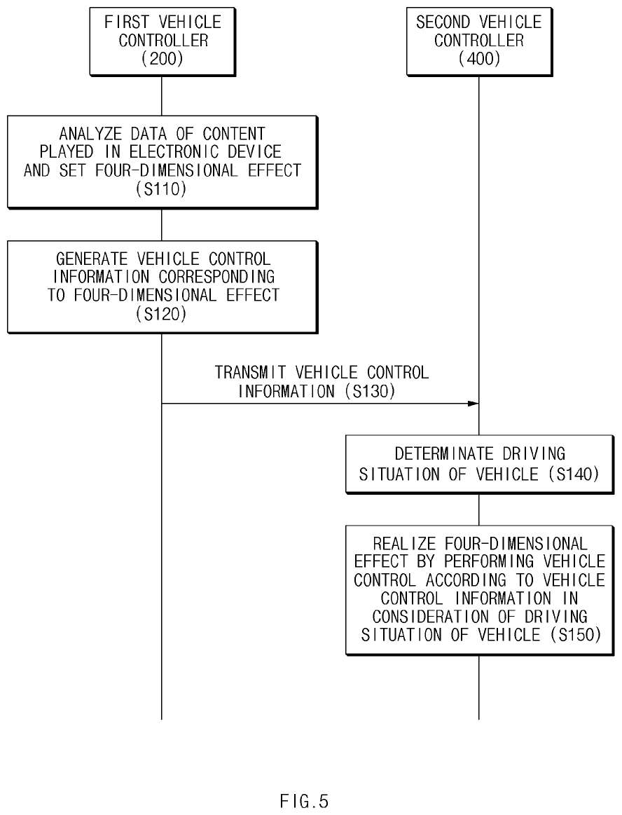

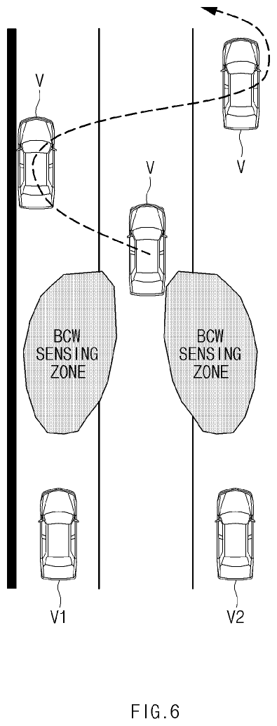

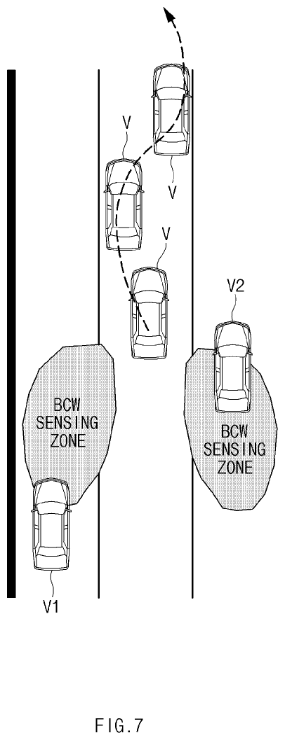

FIG. 5 is a flowchart illustrating a method for providing a four-dimensional effect in a vehicle according to an embodiment of the present disclosure, FIG. 6 is an exemplary diagram illustrating an example for providing the four-dimensional effect according to the present disclosure, and FIG. 7 is an exemplary diagram illustrating another example for providing the four-dimensional effect according to the present disclosure.

Referring to FIG. 5, the first vehicle controller 200 may analyze data of content played in the electronic device 100 and set four-dimensional effect information (S110). The electronic device 100 may play the content The first vehicle controller 200 may determine the four-dimensional effect information to be provided to the user based on at least one of position data, acceleration/deceleration data, temperature data, season data, and weather data included in the content

The first vehicle controller 200 may generate vehicle control information for realizing four-dimensional effect according to the set four-dimensional effect information (S120). The first vehicle controller 200 may generate a vehicle function to be controlled to realize the set four-dimensional effect, a control command of the corresponding function, and the like.

The first vehicle controller 200 may transmit the vehicle control information to the second vehicle controller 400 (S130). The first vehicle controller 200 may transmit the vehicle control information to the second vehicle controller 400 through the communication controller 300. The communication controller 300 may serve to transfer the vehicle control information transmitted from the first vehicle controller 200 to the second vehicle controller 400 that is to execute the corresponding vehicle control information.

The second vehicle controller 400 may determine a driving status of the vehicle (S140). For example, the second vehicle controller 400 may determine the driving status of the vehicle by determining whether a forward collision warning and a backside collision warning are functional through a second vehicle controller (ECU) mounted on the vehicle, whether a wiper is in operation, an inter-vehicle distance and/or whether a user emergency situation occurs.

The second vehicle controller 400 may realize the four-dimensional effect by performing vehicle control according to the vehicle control information in consideration of the driving status of the vehicle (S150). The second vehicle controller 400 may control the behavior of the vehicle within a range in which safety is ensured in the driving status of the vehicle to output the four-dimensional effect

As shown in FIG. 6, when a vehicle “V” is driving on a three or higher-lane highway and there are no other vehicles V1 and V2 in a backside collision warning (BCW) sensing zone, the second vehicle controller 400 may determine that the driving status of the vehicle “V” enables realization of the four-dimensional effect That is, the second vehicle controller 400 may determine that the driving status of the vehicle “V” is safe to realize the set four-dimensional effect when the backside collision warning is not functional.

The second vehicle controller 400 may control the steering of the vehicle using the left and right lanes of a mad on which the vehicle “V” is driving. The second vehicle controller 400 may control the steering such that the vehicle “V” moves zigzag on the left and right lanes of the road with the driving direction of the vehicle “V” as a reference. That is, the second vehicle controller 400 may control the behavior of the vehicle in consideration of the driving status of the vehicle, thereby maximally realizing the four-dimensional effect.

On the other hand, as illustrated in FIG. 7, when there are other vehicles V1 and/or V2 in the BCW sensing zone of the vehicle “V”, the second vehicle controller 400 may control the steering such that the vehicle “V” moves zigzag within a range that does not deviate from the lane on which the vehicle “V” is driving. That is, the second vehicle controller 400 may realize the four-dimensional effect by minimizing the four-dimensional effect in consideration of the driving status of the vehicle.

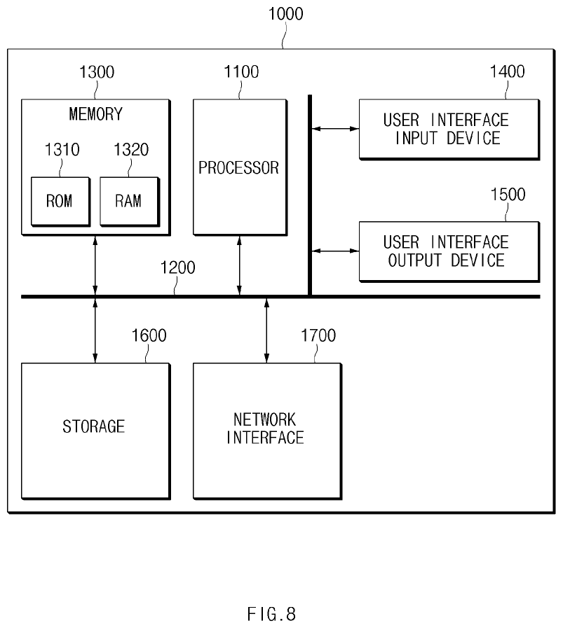

FIG. 8 is a block diagram of a computing system for executing a method for providing a four-dimensional effect according to an embodiment of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and/or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal In another case, the processor 1100 and the storage medium may reside in the user terminal as separate components.

According to the present disclosure, it is possible to provide a four-dimensional effect in a vehicle, i.e., to a driver and/or passenger(s) occupying the vehicle, by controlling a vehicle based on data of virtual reality content during driving of the vehicle, thereby providing fun entertainment elements to a user.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for providing a four-dimensional effect in a vehicle, the apparatus comprising:
a first vehicle controller configured to analyze data of content played in an electronic device, set four-dimensional effect information and generate vehicle control information for realizing the four-dimensional effect according to the set four-dimensional effect information; and
a second vehicle controller configured to perform vehicle control based on the vehicle control information in consideration of a driving status of a vehicle so that the user can feel a motion of the vehicle.

2. The apparatus of claim 1, wherein the electronic device is implemented with any one of a Virtual Reality (VR) device, a head mounted display, a wearable device, a smartphone, an Audio Video Navigation (AVN), and a vehicle display device.

3. The apparatus of claim 1, wherein the first vehicle controller sets the four-dimensional effect information based on at least one of the position data, acceleration/deceleration data, temperature data, season data, and weather data included in the content.

4. The apparatus of claim 1, wherein the second vehicle controller realizes the four-dimensional effect by controlling steering using left and right lanes of a road on which the vehicle is driving when a forward collision warning and a backside collision warning (BCW) are not functional.

5. The apparatus of claim 1, wherein the second vehicle controller realizes the four-dimensional effect by controlling steering within a lane on which the vehicle is driving when at least one of a forward collision warning and a backside collision warning (BCW) is functional.

6. The apparatus of claim 1, wherein the second vehicle controller limits speed control and steering control of the vehicle when a driving speed of the vehicle is equal to or less than a predetermined reference speed.

7. The apparatus of claim 6, wherein the second vehicle controller provides the electronic device with notification information notifying a limit to the speed control and the steering control of the vehicle.

8. The apparatus of claim 1, wherein the second vehicle controller limits speed control and steering control of the vehicle for realizing the four-dimensional effect when a wiper of the vehicle is in operation.

9. The apparatus of claim 1, wherein the second vehicle controller determines whether a user emergency situation occurs in cooperation with a health care system, and stops content reproduction of the electronic device based on a result of the determination.

10. The apparatus of claim 9, wherein the second vehicle controller allows the vehicle to stop on a shoulder of a road and performs an emergency rescue request

11. A apparatus for providing a four-dimensional effect in a vehicle, comprising:
a communicator configured to receive from an electronic device four-dimensional effect information generated by analyzing data of content played in the electronic device;
a first vehicle controller including a processor configured to generate vehicle control information for realizing the four-dimensional effect according to the four-dimensional effect information; and
a second vehicle controller configured to perform vehicle control based on the vehicle control information in consideration of a driving status of a vehicle.

12. A method for providing a four-dimensional effect in a vehicle, comprising:
analyzing data of content played in an electronic device and setting four-dimensional effect information;
generating vehicle control information for realizing the four-dimensional effect according to the four-dimensional effect information; and
performing vehicle control based on the vehicle control information in consideration of a driving status of a vehicle.

13. The method of claim 12, wherein the setting of the four-dimensional effect information includes:
setting the four-dimensional effect information based on at least one of the position data, acceleration/deceleration data, temperature data, season data, and weather data included in the content.

14. The method of claim 12, wherein the performing of the vehicle control includes realizing the four-dimensional effect by controlling steering using left and right lanes of a mad on which the vehicle is driving when a forward collision warning and a backside collision warning (BCW) are not functional.

15. The method of claim 12, wherein the performing of the vehicle control includes realizing the four-dimensional effect by controlling steering within a lane on which the vehicle is driving when at least one of a forward collision warning and a backside collision warning (BCW) is functional.

16. The method of claim 12, wherein the performing of the vehicle control includes limiting speed control and steering control of the vehicle when a driving speed of the vehicle is equal to or less than a predetermined reference speed.

17. The method of claim 16, wherein the performing of the vehicle control includes providing the electronic device with notification information notifying limit to the speed control and the steering control of the vehicle.

18. The method of claim 12, wherein the performing of the vehicle control includes limiting speed control and steering control of the vehicle for realizing the four-dimensional effect when a wiper of the vehicle is in operation.

19. The method of claim 12, wherein the performing of the vehicle control includes determining whether a user emergency situation occurs in cooperation with a health care system, and stopping content reproduction of the electronic device based on a result of the determination.

20. The method of claim 19, wherein the performing of the vehicle control includes allowing the vehicle to stop on a shoulder of a road and performing an emergency rescue request.
